(19) United States
(12) Patent Application Publication
(10) Pub. No.: US 2021/0265091 A1
(43) Pub. Date: Aug. 26, 2021

(54) Inertial Flux Compression High Magnetic Field Generator

(71) Applicant: Calvin Winter, Squamish (CA)

(72) Inventor: Calvin Winter, Squamish (CA)

(73) Assignee: Quantum Technology, Squamish (CA)

(21) Appl. No.: 17/014,031

(22) Filed: Sep. 8, 2020

Related U.S. Application Data
(63) Continuation of application No. 62/981,988, filed on Feb. 26, 2020.

(51) Int. Cl. H01F 7/06

(52) U.S. Cl. CPC H01F 7/064

(57) ABSTRACT

This invention provides for means to create a long duration high magnetic field pulse. In addition, this invention provides means for repetitive non-destructive recycling to produce a series of high magnetic field pulses. The duty cycle is the duration of high magnetic field divided by period of cycling. One objective of this invention is to increase the duty cycle, another objective of this invention is to increase the peak magnetic field.

### CROSS-REFERENCE TO RELATED APPLICATIONS

Claims benefit of Provisional Application No. 62/981,988 filed on Feb. 26, 2020.

### BACKGROUND OF THE INVENTION

### Field of the Invention

The present invention relates to the generation of high magnetic field pulses by inertial flux compression.

### Related Art

In the prior art, scientists have used magnetic confinement to create a pulse of high magnetic field. The source of the pressure to crush the shield in the prior art is by means of an explosion or by means of a second external pulse of magnetic field or by other means. In the prior art this results in a single high magnetic field pulse of short duration on the time scale of microseconds. The present invention improves upon the prior art by generating a high magnetic field pulse exceeding 100 microseconds. This enables greater duty cycle values to be achieved than in the prior art.

U.S. Pat. No. 4,435,354 describes a method where a target chamber containing a magnetic field is compressed to create a rapid rise in magnetic field strength. This invention improves on the above method by providing a means for removing and replacing the target chamber to repeat the process.

Similarly, U.S. Ser. No. 10/134,491 describes a method of generating large magnetic fields by compression. This patent uses lasers to generate a large magnetic field; whereas, the present invention utilizes a mass to generate the compression.

US patent application 20200111583 uses magnetic fields to form a magnetic confinement region to confine plasma within the chamber. The method does not disclose how the magnetic field is generated, thus differentiating itself from the present invention.

U.S. Pat. No. 4,252,605 describes a method and apparatus for compressing a lower strength magnetic field to produce high flux densities. The method utilizes a rotating liner to create the force to compress the field. The present invention utilizes the momentum from accelerated masses to compress the field.

U.S. Pat. No. 4,305,784 describes a method where a toroidal liner is surrounded by a liquid metal. Pressure applied to the liquid causes the space within the liner to decrease thereby increasing the field strength. In contrast to the present invention, the method utilizes a toroidal shape.

U.S. Ser. No. 10/726,986 describes a method to generate a compressed magnetic field by winding coils around a toroid. Over a determined portion of the toroid the size of the toroid and coils gradually decreases to compress the magnetic field. The present invention differs from this prior art by using momentum carrying masses to increase the magnetic field.

U.S. Ser. No. 10/410,752 describes a method to generate electrical energy that generates a large magnetic field. The pulse duration of the magnetic field is less than 20 ns in this method. The present invention improves upon this method by greatly increasing the pulse duration to above 100 μs.

U.S. Pat. No. 4,269,658 describes an apparatus that produces pinched plasma at high kinetic energy levels. The method relies upon rotating the apparatus to generate a centrifugal force to create a cylindrical space along the axis of the bore. The present invention differentiates itself from the prior art by the absence of the use of rotation.

### BRIEF SUMMARY OF THE INVENTION

A system for producing a high magnetic field pulse where a magnetic field is stored inside of a conductive shield and said conductive shield is crushed by momentum carrying masses pushing on said conductive shield thus reducing the surface area inside of the conductive shield and thus intensifying the magnetic field stored therein.

A further improvement to this system where the momentum of the masses is sufficient to maintain a high force on the conductive shield for an interval exceeding 100 microseconds.

A further improvement to this system, where the previously crushed conductive shield is removed and a subsequent conductive shield is automatically installed so that the cycle can be repeated.

A further improvement to this system where the duty cycle of magnetic field intensified by repetitive cycles of confinement exceeds 1/1000.

This invention provides for means to create a long duration high magnetic field pulse. In addition, this invention provides means for repetitive non-destructive recycling to produce a series of high magnetic field pulses. The duty cycle is the duration of high magnetic field divided by period of cycling. One objective of this invention is to increase the duty cycle, another objective of this invention is to increase the peak magnetic field.

### BRIEF DESCRIPTION OF THE DRAWINGS

For further understanding of the present invention, reference should be made to the following detailed description and the accompanying drawings, where like elements are given the same reference number and wherein:

FIG. 1 shows a schematic top plan view of a system for generating a high magnetic field pulse according to a particular embodiment.

FIG. 2 shows a side view of the system in FIG. 1, where the conductive magnetic shield is lowered into position inside of the pressure confining vessel.

FIG. 3 shows a schematic illustration of the system of FIG. 1 and FIG. 2 showing some other aspects of FIG. 1 and FIG. 2 in a cross-sectional view prior to crushing of the shield.

FIG. 4 shows a schematic illustration of the system of FIG. 1 and FIG. 2 showing some other aspects of FIG. 1 and FIG. 2 in a cross-sectional view after crushing of the shield.

### DESCRIPTION OF THE PREFERRED EMBODIMENT

All references identified herein are each hereby incorporated by reference into this application in their entireties, as well as for the specific information for which each is cited.

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

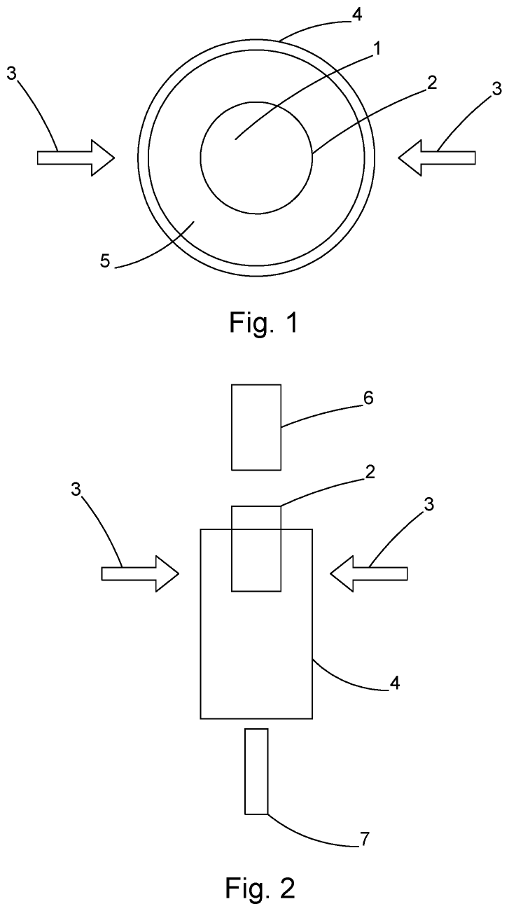

FIG. 1 is a schematic top plan view of the system herein described for generating a high magnetic field pulse according to the preferred embodiment. The scope of the invention is not limited to the specific details provided in the preferred embodiment and may also function in other embodiments. In order to create a high magnetic field pulse, first, a magnetic field is produced using any suitable technique in the region (1) where the magnetic field is trapped and will be intensified by magnetic confinement flux compression. As a non-limiting example, the magnetic field could be produced by an electromagnet. To generate the intense magnetic field, the cylindrical crushable conductive magnetic shield (2) is crushed to reduce its inner diameter. The cylindrical crushable conductive magnetic shield (2) is crushed by means of masses (3) with momentum that assists in decreasing the inner radius of the cylindrical crushable conductive magnetic shield (2). The masses (3) penetrate a strong pressure confining vessel (4) that allows the production of extremely high pressures at its interior without breaking. The annular space (5) between the strong pressure confining vessel (4) and the cylindrical crushable conductive magnetic shield (2) is filled with a high-pressure liquid that assists with crushing the cylindrical crushable conductive magnetic shield (2).

In order to repeat the cycle, the crushed conductive magnetic shield (7) from the previous magnetic pulse is then lowered out of the strong pressure confining vessel (4) by a suitable mechanism (not shown). As can be seen in FIG. 2, as the crushed conductive magnetic shield (7) is lowered from the strong pressure confining vessel (4), a new cylindrical crushable conductive magnetic shield (2) is in place for the next magnetic field pulse. Additionally, a cylindrical crushable conductive magnetic shield for the next magnetic pulse (6) is readied.

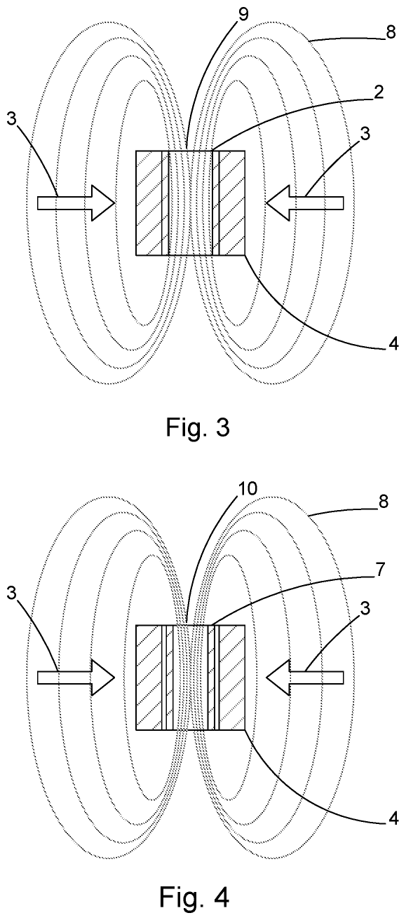

FIG. 3 shows a schematic illustration of the system in a cross-sectional view prior to the crushing of the shield. Other means produce a magnetic field (8) that is generated in the region (1). The uncompressed lines of magnetic flux (9) are shown. FIG. 4 shows the compressed lines of magnetic flux (10) after the crushing of the shield.

What is claimed is:

1. An apparatus for amplifying a magnetic field comprising, in combination:
a. at least one cylindrical crushable conductive magnetic shield and
b. a plurality of inwardly movable masses which can provide the force necessary to crush said cylindrical crushable conductive magnetic shield.

2. The apparatus as defined in claim 1 wherein said crushable conductive magnetic shield is surrounded by a reusable strong high-pressure confining vessel.

3. The apparatus as defined in claim 1 wherein said reusable strong high-pressure confining vessel supports said cylindrical crushable conductive magnetic shield.

4. The apparatus as defined in claim 1 wherein the momentum of said movable masses is sufficient to maintain an intensified magnetic field for in excess of 100 microseconds.

5. The apparatus as defined in claim 1 wherein said cylindrical crushable conductive magnetic shield can be removed and/or replaced to allow repetitive action of magnetic field compression.

6. The apparatus as defined in claim 2 wherein the annular space between said cylindrical crushable conductive magnetic shield and said reusable strong high-pressure confining vessel contains a high-pressure liquid.

7. The apparatus as defined in claim 5 wherein the removal and/or replacement of said cylindrical crushable conductive magnetic shield is in an axial direction relative to said cylindrical conductive magnetic shield.

8. The apparatus as defined in claim 5 wherein the duty cycle of said amplified magnetic field duration per repetitive cycle exceeds one part in one thousand.

9. The apparatus as defined in claim 6 wherein said high-pressure liquid assists in crushing said crushable conductive magnetic shield.

10. A method to amplify a magnetic field comprising:
a. at least one cylindrical crushable conductive magnetic shield and
b. at least one means of accelerating the inwardly movable masses to provide the force necessary to crush said cylindrical crushable conductive magnetic shield.

11. The method according to claim 10, characterized in that it also comprises a method to surround said crushable conductive magnetic shield with a reusable strong high-pressure confining vessel.

12. The method according to claim 10, characterized in that it also comprises a method to accelerate said movable masses to a speed to maintain an intensified magnetic field for in excess of 100 mircoseconds.

13. The method according to claim 11, characterized in that it also comprises a method to fill the annular space between said cylindrical crushable conductive magnetic shield and said reusable strong high-pressure confining vessel with a high-pressure liquid.

14. The method according to claim 10, characterized in that it also comprises a method for the removal and/or replacement of said cylindrical crushable conductive magnetic shield.

15. The method according to claim 14, further characterized in that it also comprises a method for the removal and/or replacement of said cylindrical crushable magnetic shield is in an axial direction relative to said cylindrical conductive magnetic shield.

16. The method according to claim 14, further characterized in that it also comprises a method for the duty cycle of said amplified magnetic field duration per repetitive cycle to exceed one part in one thousand.
